(19) United States
(12) Patent Application Publication
(10) Pub. No.: US 2022/0119738 A1
(43) Pub. Date: Apr. 21, 2022

(54) DETERGENT COMPOSITIONS HAVING IMPROVED OLFACTORY PROPERTIES

(71) Applicant: CALYXIA, BONNEUIL-SUR-MARNE (FR)

(72) Inventors: Damien DEMOULIN, BONNEUIL SUR MARNE (FR); Dounia ARCENS, BONNEUIL SUR MARNE (FR); Jamie WALTERS, BONNEUIL SUR MARNE (FR)

(73) Assignee: CALYXIA, BONNEUIL-SUR-MARNE (FR)

(21) Appl. No.: 17/425,177

(22) PCT Filed: Jan. 22, 2020
(86) PCT No.: PCT/EP2020/051506

§ 371 Date: Jul. 22, 2021

(30) Foreign Application Priority Data
Jan. 22, 2019 (FR) 19 00542

(51) Int. Cl. C11D 3/50; C11D 11/00; C11D 3/37; C11D 3/22; B01J 13/16

(52) U.S. Cl. CPC C11D 3/505; C11D 11/0017; B01J 13/16; C11D 3/222; C11D 3/3757

(57) ABSTRACT

A composition having at least one composition for washing and/or care of fabrics, and at least one solid microcapsule having a mean diameter between 1 μm and 30 μm, with a core consisting of a composition C1 comprising at least one perfuming agent, and a solid crosslinked-polymer envelope totally encapsulating the core at its circumference, wherein the solid envelope comprises a crosslinked polymer obtained by polymerizing at least one monomer or polymer having at least one reactive moiety selected from the group consisting of acrylate, methacrylate, vinyl ether, N-vinyl ether, vinyl ester, thiolene, maleate, epoxy, siloxane, amine, lactone, phosphate, and carboxylate moieties, and wherein the thickness of the solid envelope is between 0.1 μm and 20 μm.

### CROSS REFERENCE TO RELATED APPLICATIONS

The present application is a U.S. National Phase Application under 35 U.S.C. § 371 of International Patent Application No. PCT/EP2020/051506 filed Jan. 22, 2020, which claims priority of French Patent Application No. 19 00542 filed Jan. 22, 2019. The entire contents of which are hereby incorporated by reference.

### BACKGROUND

This invention concerns compositions, in particular for use in detergents or for washing and/or care of laundry, comprising microcapsules and having improved olfactory properties.

Today, scent is one of the factors for laundry care products such as detergents and fabric softeners. The sensory characteristic appreciated by consumers is for their laundry to have a pleasant, fresh scent that persists over a long period of time.

This level of olfactory performance is a real technological challenge for those present in the sector. Indeed, on the one hand, perfumes are volatile substances to tend to evaporate rapidly in the detergent or fabric softener bottle before they are able to give laundry a pleasant scent. On the other, it should be noted that perfumes, being mostly hydrophobic, have very low adhesion to laundry due to the surfactants that are also contained in laundry care products. The perfume contained in a detergent or fabric softener is thus lost to a great extent either due to evaporation or due to the washing process without ever attaching itself to the laundry and perfuming it.

One major innovation of the 2000s to address this problem is perfume microcapsules. The polymer envelope surrounding the perfume in a microcapsule has multiple benefits. First of all, the polymer envelope makes it possible to limit the evaporation rate of the perfume. Additionally, the affinity of the polymer envelope for the materials making up fabric fibers allows microcapsules to attach themselves to these fibers, thus attaching the perfume to the laundry. Lastly, microcapsules provide fabrics with a lasting fragrance because they break progressively due to mechanical effects when the fabric is in use, releasing the perfume little by little.

As such, microcapsules have allowed for improvements in the olfactory performance of detergents and fabric softeners whilst reducing the amount of perfume contained in these products, and thus their cost. However, faced with ever stricter environmental constraints, manufacturers are now seeking to make their products biodegradable. Known-art microcapsules, which are made of non-biodegradable microplastics, are a major obstacle in this context.

The main microcapsules used in detergents and fabric softeners are produced by interfacial emulsion polymerization of a compound from the formaldehyde family with a compound from the melamine family. Such compositions for fabric washing and/or care products are detailed, inter alia, in the following applications: US 2013/0203642, U.S. Pat. No. 7,119,057, WO 2015/031418, US 2015/0252312, and US 2016/177241. These capsules have performed adequately in terms of protecting the perfume from evaporation and long-lasting fragrance, but they are not biodegradable.

Biodegradable alternatives have been developed, e.g. non-polymerized, cellulose-, polycaprolactone-, or polyvinylpyrrolidone-based matrix microcapsules, described, inter alia, in applications CN106614564 or US 2015/265541. However, these microcapsules are very porous, and their ability to protect the perfume from evaporation and perfume fabrics is inadequate.

Thus, there is a need in the field for microcapsules that are biodegradable whilst further improving their ability to provide fabrics with long-lasting fragrance.

### SUMMARY

Thus, the objective of this invention is to provide a composition, in particular for washing and/or care of fabrics, that contains biodegradable microcapsules and makes it possible to provide fabrics with a long-lasting pleasant scent.

Another objective of this invention is to provide a detergent product that provides fabrics with a long-lasting pleasant scent and shows less perfume evaporation compared to current products containing microcapsules.

A further objective of this invention is to provide a detergent product that is biodegradable and provides a long-lasting pleasant scent to fabrics.

Thus, this invention concerns a composition comprising:
at least one composition for washing and/or care of fabrics, and
at least one solid microcapsule having a mean diameter between 1 μm and 30 μm, comprising:
a core consisting of a composition C1 comprising at least one perfuming agent, and
a solid crosslinked-polymer envelope totally encapsulating the core at its circumference, wherein the solid envelope comprises a crosslinked polymer obtained by polymerizing at least one monomer or polymer having at least one reactive moiety selected from the group consisting of acrylate, methacrylate, vinyl ether, N-vinyl ether, epoxy, siloxane, amine, lactone, phosphate, and carboxylate moieties,
and wherein the thickness of the solid envelope is between 0.1 μm and 20 μm, preferably between 0.2 μm and 8 μm, and more preferably between 0.2 μm and 5 μm.

This invention concerns a composition comprising:
at least one composition for washing and/or care of fabrics, and
at least one solid microcapsule having a mean diameter between 1 μm and 30 μm, comprising:
a core consisting of a composition C1 comprising at least one perfuming agent, wherein the composition C1 is in the form of an emulsion, and
a solid crosslinked-polymer envelope totally encapsulating the core at its circumference, wherein the solid envelope comprises a crosslinked polymer obtained by polymerizing at least one monomer or polymer having at least one reactive moiety selected from the group consisting of acrylate, methacrylate, vinyl ether, N-vinyl ether, thiolene, maleate, epoxy, siloxane, amine, lactone, phosphate, and carboxylate moieties,
and wherein the thickness of the solid envelope is between 0.1 μm and 20 μm, preferably between 0.2 μm and 8 μm, and more preferably between 0.2 μm and 5 μm.

Surprisingly, the inventors have found that, by associating a formula for a detergent product such as a detergent or fabric softener well known from the prior art with microcapsules made of crosslinked polymers such as crosslinked polyesters, crosslinked polyepoxys, or crosslinked polyurethanes, the resultant detergent product will have the following properties:
it provides fabrics with a long-lasting pleasant scent;
it shows less perfume evaporation than products containing prior-art microcapsules, and
it is biodegradable.

The composition according to the invention combines a composition normally used for washing and/or caring for fabrics, but not containing microcapsules, as discussed in detail below, with biodegradable microcapsules having a core containing a perfuming agent.

According to the invention, the microcapsules do not comprise a composition for washing and/or caring for fabric. In particular, the core of the microcapsules used according to the invention does not comprise any fabric softeners, detergents, or any other such product.

In particular, this invention consists of using biodegradable microcapsules having a core that contains a perfuming agent to improve the olfactory properties of fabric washing and/or care compositions such as detergents and fabric softeners.

Within the meaning of this application, the terms ‘microcapsules’ and ‘capsules’ are synonymous.

As noted above, the compositions of the invention comprise a composition for washing and/or caring for fabrics.

These fabric washing and/or care compositions are selected om known-art compositions intended for cleaning and maintenance of fabrics, but also for bleaching, wrinkle removal, softening, to facilitate ironing, or to prevent abrasion or pilling.

Preferably, these compositions do not comprise (micro)capsules.

In particular, the compositions for washing and/or care of fabrics are detergent compositions, in particular detergent compositions in liquid, powder, or tablet form. Preferably, the fabric washing and/or care compositions according to this invention are detergent compositions, in particular primary detergent (fabric cleaning) compositions or fabric softener compositions added to the rinse, in particular as described in the following applications: EP 1 954 793, WO 2016/003699, U.S. Pat. No. 9,284,261, or WO 2015/150124.

The primary washing compositions may include a fabric softener, and fabric softeners added to the rinse may include surfactants, in particular nonionic surfactant compounds.

The selection of the surfactant compound and the quantity present depend on the intended use of the detergent composition. In compositions for washing fabrics, various surfactant systems may be selected, as is well known to persons skilled int he art, in order to adapt them, e.g., to different types of fabrics or washing machines.

The total amount of surfactant included will also depend on the intended end use, and may be up to 60 wt %, e.g., in a composition for hand-washing fabrics. In compositions for machine-washing fabrics, an amount of 5-40 wt % is generally appropriate. Typically, the fabric washing and/or care compositions used according to the invention comprise at least 2 wt % surfactant, preferably 2-60 wt %, in particular 15-40 wt %, and preferably 25-35 wt % relative to the total weight of the composition.

Detergent compositions suitable for use in most automated washing machines generally contain a soap-free anionic surfactant, or a nonionic surfactant, or combinations of the two in any suitable ratio, optionally with soap.

In one embodiment, the fabric washing and/or care compositions used according to the invention comprise at least one surfactant, in particular one selected from the anionic, cationic, nonionic, amphoteric, and zwitterionic surfactants and mixtures thereof, and in particular as described in detail in the literature, e.g. in ‘Surfaces active [sic] Agents and Detergents’, volumes I and II, Schwartz, Perry, and Berch.

In one embodiment, the fabric washing and/or care compositions used according to the invention comprise at least one anionic surfactant, in particular one selected from the linear alkylbenzenesulphonates, in particular linear alkylbenzenesulphonates having an alkyl chain length of C8-C16. Preferably, the surfactant content is between 0 and 40 wt %, in particular between 1 and 25 wt %, and more preferably between 2 and 15 wt %, relative to the total weight of the composition.

Additional examples of anionic surfactants include saturated or unsaturated alkaline fatty acid salts having 12-18 carbon atoms, sulphuric acid-fatty alcohol hemiester salts having 12-18 carbon atoms, and sulphating products of the aforementioned nonionic surfactants having a low degree of ethoxylation; primary and secondary alkylsulphates, in particular branched statistical primary C8-C15 alkylsulphates; secondary C10-C18 (2,3)alkylsulphates; alkyl ether sulphates; sulphated fatty alcohol ethoxylates (FAE) preferably alkyl alkylalkoxy sulphates; C10-C18 alkyl alkylalkoxycarboxylates; mid-chain branched alkylsulphates; mid-chain branched alkyl alkoxy sulphates; modified alkylbenzenesulphonates; methyl ester sulphonates; olefin sulphonates; alkyl xylene sulphonates; dialkyl sulphosuccinates; and fatty acid sulphonate esters. Generally, sodium salts are preferred.

In one embodiment, the fabric washing and/or care compositions used according to the invention comprise at least one nonionic surfactant.

Examples of nonionic surfactants include alkylglycoside ethoxylates or propoxylates and/or primary and secondary alcohols, in particular C8-C20 ethoxylated aliphatic alcohols having an average of 1-20 mol of ethylene oxide per mole of alcohol, and primary C10-C15 ethoxylated aliphatic alcohols; C6-C12 alkyl alkylphenol alkoxylates in which the alkoxylate motifs are a mixture of ethyleneoxy and propyleneoxy units; C12-C18 alcohol and C6-C12 alkylphenol condensates with alkyl polyamine ethoxylates having the sequence ethylene oxide/propylene oxide; alkylpolysaccharides; polyhydroxylic fatty acid amides; and alkoxylated ester surfactants such as fatty methyl ester ethoxylates (MEE).

Examples of nonionic surfactants also include non-ethoxylated nonionic surfactants such as alkylpolyglycosides, glycerol monoethers, and polyhydroxyamides (glucamide), ethoxylation and/or propoxylation products of N-alkylamines, vicinal diols vicinaux, fatty acid esters, and fatty acid amides.

Such surfactants may be contained in these compositions in amounts between 0 and 40 wt %, preferably 1 and 25 wt %, more preferably between 2 and 15 wt % relative to the total weight of the composition.

In one embodiment the fabric washing and/or care compositions used according to the invention comprise at least one amphoteric surfactant.

Examples of amphoteric surfactants include secondary and tertiary amine derivatives, secondary and tertiary heterocyclic amine derivatives, or derivatives of quaternary ammonium, quaternary phosphonium, or tertiary sulphonium compounds such as betaine, including alkyldimethylbetaine and cocodimethylamidopropylbetaine, C8-C18 amine oxides, and sulpho- and hydroxybetaines, such as N-alkyl-N, N-dimethylamino-1-propanesulphonate, wherein one alkyl group may be a C8-C18 or C10-C14 alkyl group; water-soluble amine oxides such as C10-C18 alkyl dimethyl amine oxide or C8-C12 alkoxyethyl dihydroxyethyl oxide.

In one embodiment, where the fabric washing and/or care composition is a fabric softener, the composition contains at least one cationic softening compound for softening fabrics.

Examples of cationic softening compounds include cationic surfactants such as quaternary ammonium salts having a water solubility less than 1×10⁻³ wt % in demineralized water at 20° C., comprising a single long alkyl or alkenyl chain having an average length greater than or equal to C20; preferably, compounds comprising a polar head group and two alkyl or alkenyl chains with an average chain length greater than or equal to C14. Preferably, these compounds have two long alkyl or alkenyl chains, each of which has an average length greater than or equal to C16. Preferably, at least 50% of the alkyl or alkenyl groups have a chain length of C18 or greater. It is preferred for the long-chain alkyl or alkenyl groups to be mainly linear. For example, distearyldimethyl ammonium chloride and di (hardened tallow alkyl) dimethyl ammonium, di (sulphoxyloxyethyl) dimethyl ammonium and/or its tallow analogue, triethanolamine (TEA quats) derivatives such as tallow N-methyl-N,N,N-triethanolamine diester or quaternary tallow ammonium chloride diester, or tallow methosulphate diester. Other examples include quaternarydimethylhydroxyethylammonium, chlorure de dimethylhydroxyethyl lauryl ammonium, benzalkonium chloride (N-alkyl-N,N-dimethylbenzylammonium chloride), benzalkon B (C2-2 m,p-dichlorobenzyl dimethyl-alkyl chloride), benzoxonium chloride, (2-hydroxyethyl)ammonium chloride, cetrimonium bromide (N-hexadecyl-N,N-trimethylammonium bromide), benzethonium chloride, dialkyldimethylammonium chlorides such as di-n-decyldimethylammonium chloride, didecyldimethylammonium bromide, dioctyldimethylammonium chloride, 1-cetylpyridinium chloride, benzalkonium chlorides having C8-C22 alkyl residues, methyl-N-(2-hydroxyethyl)-N,N-di(acupoxyethyl)ammonium methosulphate, bis(palmitoyl)ethylhydroxyethyl methylammonium methosulphate, or (2-hydroxyethyl) ammonium methyl-N,N-bis(acyloxyethyl)-N-methosulphate, as well as cationic polyamines.

Such cationic softening compounds may be contained in these compositions in amounts of 0.5-35 wt %, preferably 1-30 wt %, more preferably 3-25 wt % relative to the total weight of the composition.

In one embodiment, if the fabric washing and/or care composition is a fabric-softening composition, the composition contains at least one biodegradable cationic fabric-softening compound such as biodegradable quaternary ammonium-based materials, etc. 1,2-bis (hardened sulphoyloxy)-3-trimethylammonium propane chloride, as described in U.S. Pat. No. 4,137,180. Preferably, these materials comprise small amounts of the corresponding monoester, e.g. hardened sulphoyloxy-2-hydroxy-3-trimethylammonium propane chloride.

Examples of cationic fabric-softening compounds also include alkylpyridinium salts, substituted imidazoline species, primary, secondary, and tertiary amines, and the condensation products of fatty acids and alkylpolyamines.

Such cationic compounds may be contained in these compositions in amounts of 0.5-35 wt %, preferably 1-30 wt %, more preferably 3-25 wt % relative to the total weight of the composition.

In one embodiment, if the fabric washing and/or care composition is a fabric-softening composition, the composition contains at least one water-soluble cationic fabric-softening compound as described in GB 2 039 556.

In one embodiment, if the fabric washing and/or care composition is a fabric-softening composition, the composition contains at least one nonionic fabric-softening compound, such as lanolin and its derivatives, lecithins, and other phospholipids.

In one embodiment, the fabric washing and/or care compositions used according to the invention comprise at least one stabilizing agent, in particular in order to stabilize the microcapsules.

Examples of stabilizing agents include any known ingredient capable of suspending particles and/or adjusting the rheology of a liquid composition, in particular crystalline materials containing a hydroxy group, polyacrylates, polycarboxylates, alkaline metal salts, alkaline earth metal salts, ammonium salts, alkanolammonium salts, C12-C20 fatty alcohols, di-benzylidene polyol (DBPA) acetate derivatives, cationic polymers comprising a first structural motif derived from methacrylamide and a second structural motif derived from diallyldimethylammonium chloride, and a combination thereof. Linear C8-C22 alcohols alkoxylated with 10-20 mol alkylene oxide, C10-C20 alcohols, and mixtures thereof may also be used. Other stabilizing agents comprise deflocculant polymers as described in EP 0 415 698 and EP 0 458 599. Advantageously, the nonionic stabilizing agent is a C8-C22 linear alcohol alkoxylated with 10-20 mol alkylene oxide. Gums and other polysaccharides may also be advantageously used, e.g., gellan gum, carrageenan gum, xanthan gum, polyvinyl alcohol and derivatives thereof, cellulose and derivatives thereof, including cellulose ethers and cellulose esters, and tamarind gum (comprising, e.g., xyloglucan polymers), guar gum, carob gum. Lastly, examples further include fatty acids and fatty waxes, e.g. C8-C24 monocarboxylic alkyl or alkenyl acids and polymers thereof, castrol oil, and derivatives thereof. Preferably, saturated fatty acids, in particular hardened C16-C18 tallow fatty acids, are used. Preferably, the fatty acid is not saponified, more preferably, the fatty acid is free, e.g. oleic acid, lauric acid, or tallow fatty acid.

Such stabilizing agents may be contained in these compositions in amounts of 0.1-10 wt %, preferably 0.5-5 wt %, more preferably 1-4 wt % relative to the total weight of the composition.

In one embodiment, the fabric washing and/or care compositions used according to the invention comprise at least one inorganic additive improving the detergent properties of the product, such as sodium carbonate, optionally combined with a crystallization germ for calcium carbonate, amorphous crystalline aluminosilicates such as zeoliths, inorganic phosphates and polyphosphates such as sodium orthophosphate de sodium, pyrophosphate, and tripolyphosphate.

Preferably, such inorganic additives are present in amounts between 5 and 40 wt % relative to the total weight of the composition.

In one embodiment, the fabric washing and/or care compositions used according to the invention comprise at least one organic detergent additive such as polycarboxylic acids, in particular citric acid, adipic acid, succinic acid, glutaric acid, malic acid, tartaric acid, malaric acid, fumaric acid, and saccharic acids, monomeric and polymeric aminopolycarboxylic acids, in particular methylglycinediacetic acid, nitrilotriacetic acid, and ethylenediamine-tetraacetic acid and polyaspartic acid, polyphosphonic acids, in particular aminotris (methylene phosphonic acid) acid, ethylenediaminetetrakis (methylene phosphonic acid) compounds, and polymeric acids such as (poly) dextrin, polymeric acrylic acids, methacrylic acids, maleic acids, and polymer mixtures thereof. All of the aforementioned acids are generally used in the form of their water-soluble salts, in particular their alkaline salts.

Preferably, such organic detergent additives are included in amounts of 0.5-25 wt %, preferably 1-10 wt % relative to the total weight of the composition.

In one embodiment, the fabric washing and/or care compositions used according to the invention comprise at least one polycarboxylate monomer-type organic detergent additive such as citrates, gluconates, oxidisuccinates, glycerol mono-, di-, and trisuccinates, carboxymethyloxy succinates, carboxymethyloxymalonates, dipicolinates, hydroxyethyliminodiacetates, alkyl- and alkenylmalonates and succinates, and sulphonated fatty acid salts.

Preferably, such organic detergent additives are included in amounts of 5-30 wt %, preferably 10-25 wt % relative to the total weight of the composition.

In one embodiment, the fabric washing and/or care compositions used according to the invention comprise at least one peroxide bleach compound, e.g. inorganic persalts or organic peroxy acids, capable of producing hydrogen peroxide in aqueous solution. Suitable peroxide bleach compounds comprise organic peroxides such as urea peroxide and inorganic persalts such as alkaline metal perborates, percarbonates, perphosphates, persilicates, and persulphates. Examples include mono- and tetrahydrated sodium perborate and sodium percarbonate, phtalimidoperoxycaproic acid, peroxybenzoic acid, hypohalite, peroxyacetic acid, diperoxoazelaic acid, diperoxododecanedioic, and oxidating enzyme systems or diperoxidodecanedioic acid salts.

Preferably, such peroxide bleach compounds are included in amounts of 0.1-35 wt %, preferably 0.5-25 wt % relative to the total weight of the composition.

In one embodiment, the fabric washing and/or care compositions used according to the invention comprise at least one bleach activator or precursor that may be used together with the bleaching compound to improve the bleaching effect at low washing temperatures, such as catalytic metal complexes, peroxycarboxylic acid precursors, more particularly peracetic acid precursors and pernonanoic acid precursors, e.g. N,N,N′,N′-tetracetyl ethylenediamine (TAED), sodium nonanoyloxybenzene sulphonate (SNOBS), octanoylcaprolactam, benzoyloxybenzenesulphonate, nonanoyloxybenzenesulphonate, benzoylvalerolactolactam, and methyl dodecanobenzylacrylate. Likewise, a peroxy acid may be used, such as imidoperoxycarboxylic peracids and phtalimidoperoxycaproic acid (PAP).

Preferably, such bleach activators or precursors are included in amounts of 0.1-8 wt %, preferably 0.5-5 wt % relative to the total weight of the composition.

In one embodiment, the fabric washing and/or care compositions used according to the invention comprise at least one bleach stabilizer (transition metal sequestering agent) tel such as ethylenediamine tetra-acetate (EDTA), polyphosphonates such as Dequest™ and non-phosphate stabilizers such as EDDS (ethylene diamine di-succinic acid).

In one embodiment, the fabric washing and/or care compositions used according to the invention comprise at least one enzyme such as those of the protease class (in particular, subtilisins), cutinases, amylases, pullulanases, hemicellulases, cellulases, hemicellulase mannanases, pectin-separating enzymes, tannases, xylanases, xanthanases, β-glucosidases, carrageenases, perhydrolases, oxidases, oxidoreductases, lipases, and peroxidases, as well as mixtures thereof. Particularly suitable are the enzyme-active substances obtained from fungi or bacteria, such as Bacillus subtilis, Bacillus licheniformis, Streptomyces griseus, Humicola lanuginosa, Humicola insolens, Pseudomonas pseudoalcaligenes, or Pseudomonas cepacia. Any enzymes used may be adsorbed on carrier substances and/or incorporated in encapsulating substances in order to protect them from premature inactivation.

Preferably, such enzymes are present in amounts of app. 0.1 and app. 3.0 wt % relative to the total weight of the composition.

In one embodiment, the fabric washing and/or care compositions used according to the invention comprise at least one powder structuring agent, such as a fatty acid (or a fatty acid soap), a sugar, an acrylate or acrylate/maleate copolymer, or sodium silicate.

Preferably, such powder structuring agents are present in amounts of 1-5 wt % relative to the total weight of the composition.

The fabric washing and/or care compositions used according to the invention may further comprise other additives, such as soil-release polymers, inorganic salts such as sodium sulphate or sodium hydroxide; coloring agents; and decoupling polymers.

In one embodiment, the fabric washing and/or care compositions used according to the invention comprise at least one free, i.e., non-encapsulated, perfuming agent. Such perfuming agents are well known to persons skilled in the art, and include, inter alia, those mentioned, e.g., in S. Arctander, Perfume and Flavor Chemicals (Montclair, N.J., 1969), S. Arctander, Perfume and Flavor Materials of Natural Origin (Elizabeth, N.J., 1960), on the list of the International Fragrance Association (IFRA http://www.ifraorg.org/en/ingredients), and in “Flavor and Fragrance Materials”, 1991 (Allured Publishing Co. Wheaton, Ill. USA).

Preferably, such free perfuming agents are included in amounts of 0.1-5 wt %, preferably 0.2-3 wt % relative to the total weight of the composition.

In one embodiment, the fabric washing and/or care compositions used according to the invention comprise at least one anti-foaming agent, such as a silicone or paraffin oil.

Preferably, such anti-foaming agents are included in amounts of 0.05%-4 wt %, preferably 0.1%-3 wt %, and more preferably 0.2%-1wt % relative to the total weight of the composition.

In one embodiment, the fabric washing and/or care compositions used according to the invention comprise at least one degreasing agent or antiredposition agent, such as nonionic cellulose ethers such as methylcellulose, carboxymethylcellulose, methylhydroxypropylcellulose, phthalic acid and/or terephthalic acid polymers, in particular ethylene terephtalate and/or polyethylene glycol terephtalate polymers, or anionically and/or nonionically modified derivatives thereof, preferably in an amount between 0 and 5 wt % relative to the total weight of the composition.

In one embodiment, the fabric washing and/or care compositions used according to the invention comprise at least one color transfer inhibitor or anti-discoloring agent, such as derivatives of polyvinylpyrrolidone (PVP), polyvinylimidazole (PVI), vinylpyrrolidone and vinylimidazole (PVP/PVI) copolymers, polyvinylpyridine-N-oxide, poly-N-carboxymethyl-4-vinylpyridium chloride, vinylpyrrolidone and vinylimidazole polyethylene glycol copolymer, and mixtures thereof, preferably in an amount between 0 and 2 wt % relative to the total weight of the composition.

In one embodiment, the fabric washing and/or care compositions used according to the invention comprise at least one optical brightener, which may include any compound having fluorescence, including compounds that absorb UV light and re-emit it in the form of ‘blue’ visible light. Such brighteners include: stilbene, de 4,4′-diaminostilbene, biphenyle, and distyrylbiphenyle derivatives, 5-membered heterocycles such as triazoles, pyrazolines, oxazoles, imidiazoles, or 6-membered heterocycles (such as coumarins, naphtalamides, s-triazines).

Preferably, such optical brighteners are included in amounts of 0-0.4 wt %, preferably 0.1-0.3 wt % relative to the total weight of the composition.

In one embodiment, the fabric washing and/or care compositions used according to the invention comprise at least one non-aqueous solvent, such as mono- or polyhydric alcohols, alkanolamines, or glycol ethers, provided that they are miscible in water in the specified concentration range. Preferably, the solvents are selected from ethanol, n-propanol, isopropanol, butanols, glycol, propanediol, butanediol, methylpropanediol, glycerol, diglycol, propyldiglycol, butyl diglycol, hexylene glycol, ethylene glycol, ethylene glycol, ethylene glycoland ethylene glycol, ethylene glycol propylene ether, ethylene glycol mono-n-butyl ether, diethylene glycol methyl ether, diethylene glycol ethyl ether, propylene glycol methyl ether, ethyl ether de propylene glycol, propylene glycol propyl ether, dipropylene glycol monomethyl ether, dipropylene glycol monoethyl ether, methoxy triglycol, ethoxy triglycol, butoxy triglycol, 1-butoxyethoxy-2-propanol, 3-methyl-3-methoxybutanol, propyleneglycol ether, t-butylether, di-n-octyl ether, and mixtures of these solvents.

Preferably, such non-aqueous solvents are included in amounts of 0-25 wt %, preferably 1%-20 wt %, and more preferably 2-15 wt % relative to the total weight of the composition.

In one embodiment, the fabric washing and/or care compositions used according to the invention comprise water.

As noted above, the compositions according to the invention comprise at least one solid microcapsule as defined above.

Preferably, the compositions according to the invention comprise several solid microcapsules, i.e. a series or group of solid microcapsules, all of which are identical or different.

The microcapsules according to the invention are referred to as ‘solid microcapsules’ because of the solid nature of the crosslinked polymer envelope.

In one embodiment, the solid microcapsules according to the invention comprise a liquid (non-solid) core.

Given the choice of specific monomers and polymers, the microcapsules used according to the invention are capable of being biodegradable.

Biodegradability is defined here as the ability to be degraded in a natural environment as defined in the OECD guidelines: OECD 301 (Ready biodegradability), i.e. OECD 301 A (Dissolved Organic Carbon (DOC) Die-Away), OECD 301 B (CO2 evolution test), OECD 301 C (modified MITI test (I)), OECD 301 D (closed bottle test), OECD 301 E (modified OECD screening test), OECD 301 F (Manometric respiration test), or OECD 304A (Soil biodegradation), OECD 306 (Biodegradability in seawater), and OECD 310 (Ready biodegradability—CO2 in sealed vessels (Headspace Test)).

The microcapsules according to the invention are characterized by the fact that they comprise a core comprising at least one perfuming agent, wherein the perfuming agent is different to the fabric washing and/or care composition.

According to the invention, the aforementioned fabric washing and/or care composition and the solid microcapsules(series or groups of solid microcapsules) are different entities.

In one embodiment, the composition according to the invention comprises solid microcapsules, wherein each of the solid microcapsules is as defined above, and wherein the standard deviation of the microcapsule diameter distribution is less than 50 %, or less than 1 μm.

The size distribution of the solid microcapsules may, for example, be measured by image analysis of the microcapsules selected or by optical microscope, or by light diffusion using a Mastersizer 3000 (Malvern Instruments) with a Hydro SV measurement cell.

As mentioned above, the composition C1 is preferably in the form of an emulsion, and thus comprises a continuous phase and a dispersed phase.

In one embodiment, the above-defined composition C1 of the core of the solid microcapsules comprises at least 20 wt % of a perfuming agent relative to the total weight of the composition C1, and preferably 25-60 wt %, more preferably 30-50 wt % relative to the total weight of the composition C1.

In one embodiment, the composition C1 further comprises at least one gellant.

The gellant may be selected from the group of water-soluble or -dispersible polymers, in particular including aqueous (sic!), preferably selected from the following group:
cellulose derivatives, such as cellulose ethers: methylcellulose, ethylcellulose, hydroxyethylcellulose, methylhydroxyethylcellulose, ethylhydroxyethylcellulose, carboxymethylcellulose, hydroxypropylcellulose or methylhydroxypropylcellulose;
polyacrylates (also known as carbomers), such as polyacrylic acid (PAA), polymethacrylic acid (PMAA), poly(hydroxyethyl methacrylate) (pHEMA), poly(N-2-hydroxypropyl methacrylate) (pHPMA);
polyacrylamides such as poly(N-isopropylacrylamide) (PNIPAM);
polyvinylpyrrolidone (PVP) and derivatives thereof;
polyvinyl alcohol (PVA) and derivatives thereof;
poly(ethylene glycol), poly(propylene glycol), and derivatives thereof, such sa poly(ethylene glycol) acrylate/methacrylate, poly(ethylene glycol) diacrylate/dimethacrylate, polypropylene carbonate;
polysaccharides such as carrageenans, carob or tara goms, dextran, xanthan gums, chitosan, agarose, hyaluronic acids, gellan gum, guar gum, gum arabic, tragacanth gum, diutan gum, oat gum, karaya gum, ghatti gum, curdlan gum, pectin, konjac gum, starch;
protein derivatives such as gelatin, collagen, fibrin, polylysine, albumin, casein;
polyurethanes and derivatives thereof.

The gellant may also be selected from the group of solid particles such as clays, silica, and silicates that can be used as gellants when dispersed in water.

Examples of solid particles that can be used in the composition C1 as gellants include clays and silicates, in particularly in the category of phyllosilicates (also known as ‘flaky silica’). Examples of silicates that can be used in the invention include bentonite, hectorite, attapulgite, sepiolite, montmorillonite, saponite, sauconite, nontronite, kaolinite, talc, sepiolite, and chalk. Fumed synthetic silicates may also be used. The aforementioned clays, silicates, and silicas may advantageously be modified by organic molecules such as polyethers, ethoxylated amides, quarternary ammonium salts, long-chain diamines, long-chain esters, polyethylene glycols, and polypropylene glycols.

Preferably, the gellant is selected from the group consisting of cellulose derivatives, polyacrylates, poly(ethylene glycol) derivatives, and synthetic silicas.

In one embodiment, the composition C1 comprises between 0.1 and 30 wt % of gellant, preferably between 0.5 and 20 wt %, more preferably between 0.5 and 10 wt %.

In one embodiment, the composition C1 comprises between 30 and 70 wt % of water, preferably between 35 and 65 wt %, more preferably between 35 and 60 wt %.

In one embodiment, the composition C1 further comprises at least one surfactant, in particular one selected from the anionic, cationic, amphoteric, and nonionic surfactants. Examples of surfactants include oxyethylenated/oxypropylenated bloc polymers such as Poloxamers; fatty acid esters of sorbitan and oxyethylenated derivatives thereof, such as sorbitan monostearate, sorbitan monopalmitate, oxyethylenated sorbitan stearates, palmitates, and oleates; derivatives of polyethylene glycol and a mixture of caprylic and capric acid glycerides (mono-, di-, and triglycerides); alkylpolyglycosides, and, in particular, alkylpolyglucosides such as caprylyl/capryl glucoside or laurylglucoside.

In one embodiment, the composition C1 further comprises at least one agent for adjusting the hydrophobicity of the perfume. These agents are hydrophic materials having a C log P greater than 4, preferably greater than 6, and having good miscibility with the perfumes used. Examples of these agents include mono-, di and triglyceride oils such as capric/caprylics triglycerides; fatty acid esters of polyglycerol, polyethylene glycol, polypropylene glycol, and polybutylene glycol oligomers; nonionic fatty alcohol alkoxylates such as isopropyl myristate, diethyl phthalate, dibutyl phthalate, diisodecyl adipate; mineral oils; silicone oils such as polydimethylsiloxane and polydimethylcyclosiloxane; diethyl phtalate; polyalphaolefines; castor oil.

Preferably, the composition C1 is in the form of a nanoemulsion in which the continuous phase is an aqueous gel. Preferably, the average diameter of the droplets of the nanoemulsion is between 50 nm and 5 μm, preferably between 100 nm and 3 μm, and more preferably between 100 nm and 1 μm.

Preferably, the composition C1 is in the form of an emulsion in which the continuous phase is an aqueous gel.

Preferably, the average diameter of the droplets of the emulsion is between 50 nm and 5 μm, preferably between 100 nm and 3 μm, and more preferably between 100 nm and 1 μm.

The inventors have found that one decisive parameter for limiting the evaporation of the perfuming agent of the microcapsules is the stability of the emulsion of the composition C1 over time, i.e. that the size distribution changes very little over time.

To attain this level of stability, the addition of a gellant is particularly advantageous because it makes it possible to slow the coalescence of the droplets of the emulsion.

As mentioned above, the composition C1 comprises at least one perfuming agent.

Thus, the composition C1 according to the invention may comprise a single perfuming agent (or perfume), or a mixture of several perfuming agents (or perfumes).

Examples of perfuming agents include all types of perfumes or fragrances; these terms are used synonymously herein. These perfumes or fragrances are well known to persons skilled in the art, and include, inter alia, those mentioned, e.g., in S. Arctander, Perfume and Flavor Chemicals (Montclair, N.J., 1969), S. Arctander, Perfume and Flavor Materials of Natural Origin (Elizabeth, N.J., 1960), on the list of the International Fragrance Association (IFRA http://www.ifraorg.org/en/ingredients), and in “Flavor and Fragrance Materials”, 1991 (Allured Publishing Co. Wheaton, Ill. USA).

The perfumes used in this invention may comprise natural products such as extracts, essential oils, absolutes, resinoids, resins, concretes, etc., as well as basic substances for synthesis such as hydrocarbons, alcohols, aldehydes, ketones, ethers, acids, esters, acetals, ketals, nitriles, etc., including saturated and unsaturated compounds, aliphatic, alicyclic, and heterocyclic compounds.

In one embodiment, the perfuming agent comprises less than 10 wt %, or less than 7.5 wt % of any compound(s) having a C log P below 2.1, relative to the total weight of the perfuming agent. In one embodiment, the perfuming agent comprises no compounds having a C log P below 2.1.

In one embodiment, the aforementioned solid microcapsules comprise a solid envelope that consists entirely of a crosslinked polymer as defined above.

The aforementioned solid envelope consists of a crosslinked polymer obtained by polymerizing at least one monomer or polymer having at least one reactive moiety selected from the group consisting of acrylate, methacrylate, vinyl ether, N-vinyl ether, vinyl ester, thiolene, maleate, epoxy, siloxane, amine, lactone, phosphate, and carboxylate moieties.

Within the meaning of the invention, the term ‘monomer’ or ‘polymer’ includes any basic unit suited for the formation of a solid material by means of polymerization, whether alone or in combination with other monomers or polymers. The term ‘polymer’ also encompasses oligomers.

In one embodiment, the crosslinked polymer is obtained by polymerization from a monomer or polymer selected from aliphatic or aromatic esters or polyesters, urethanes or polyurethanes, anhydrides or polyanhydrides, saccharides or polysaccharides, ethers or polyethers, amides or polyamides, and carbonates or polycarbonates, wherein the monomers or polymers further include at least one reactive moiety selected from the group consisting of acrylate, methacrylate, vinyl ether, N-vinyl ether, vinyl ester, thiolene, maleate, epoxy, siloxane, amine, lactone, phosphate, and carboxylate moieties.

Examples of such monomers or polymers include, without limitation, the following compounds and mixtures thereof:
the aliphatic or aromatic ester and polyester family, comprising in particular polyglycolides (PGA), polylactides (PLA), poly(lactide-co-glycolide) (PLGA), poly(ortho esters), such as polycaprolactone (PCL), polydiaxanone, poly(ethylene succinate), poly(butylene succinate) (PBS), poly(ethylene adipate), poly(butylene adipate), poly(ethylene sebacate), poly(butylene sebacate), poly(valero lactone) (PVL), poly(decalactone), polyhydroxyvalerate, poly(beta-malic acid), poly-3-hydroxybutyrate (PHB), poly-3-hydroxy-butyrate-co-3-hydroxyvalerate (P-3HB-3HV), poly-3-hydroxybutyrate-co-4-hydroxybutyrate (P-3HB-4HB), poly-3-hydroxybutyrate-co-3-hydroxyvalerate-co-4-hydroxybutyrate (P-3HB-3HV-4HB), poly (3-hydroxy valerate), poly (3-hydroxypropionate), poly (3-hydroxycaproate), poly (3-hydroxyoctanoate), poly (3-hydroxidecanoate), poly (3-hydroxyundecanoate), poly (3-hydroxidodecanoate), poly (3-hydroxybutyrate-co-3-hydroxy valerate), poly(3-hydroxybutyrate-co-3-hydroxidecanoate), poly(3-hydroxybutyrate-co-3-hydroxypropionate), poly(3-hydroxybutyrate-co-3-hydroxyoctanoate), poly(3-hydroxyheptanoate), poly(3-hydroxyhexanoate), poly(2-hydroxybutyrate), poly(3-hydroxybutyrate-co-4-hydroxybutyrate), poly(3-hydroxybutyrate-co-3-hydroxyhexanoate), poly(3-hydroxybutyrate-co-3-hydroxyhexanoate), poly(4-hydroxybutyrate), poly(4-hydroxybutyrate-co-2-hydroxybutyrate), poly(4-hydroxypropionate), poly(4-hydroxyvalerate), poly(5-hydroxybutyrate), poly(5-hydroxyvalerate), poly(6-hydroxyhexanoate), poly(alkylene alkanoate), poly(alkylene dicarboxylate), poly(butylene adipate), poly(butylene adipate-co-terephthalate), poly(butylene carbonate), poly(butylene pimelate), poly(butylene succinate), poly(butylene succinate-co-adipate), poly(butylene succinate-co-carbonate), poly(butylene sebacate), poly(butylene sebacate-co-terephthalate), poly(butylene succinate-co-terephthalate), poly(butylene succinate-co-lactate), poly(cyclohexène carbonate), polydiaxanone, poly(ethylene azelate), poly(ethylene carbonate), poly(ethylene decamethylate), poly(ethylene furanoate), poly(ethylene oxalate), poly(ethylene succinate), poly(ethylene succinate-co-adipate), poly(ethylene sebacate), poly(ethylene succinate-co-terephthalate), poly(ethylene subérate), poly(hexamethylene sebacate), poly(glycolide-co-caprolactone), poly(lactide-co-epsilon-caprolactone), polymandelide, poly (B-malic acid), poly(b-propiolactone), poly(propylene succinate), poly(tetramethylene adipate-co-terephthalate), poly(tetramethylene carbonate), poly(trimethylene carbonate), poly(tetramethylene succinate)-co-(tetramethylene carbonate), poly(trimethylene adipate), poly(methylene adipate-co-terephthalate), poly(tetramethylene adipate), poly(tetramethyl glycolide), poly(butylene succinate), poly(valero lactone), further including at least one reactive moiety selected from the group consisting of acrylate, methacrylate, vinyl ether, N-vinyl ether, vinyl ester, thiolene, maleate, epoxy, siloxane, amine, ctone, phosphate, and carboxylate moieties;
the family of anhydrides or polyanhydrides, such as those derived from polysebacic acid, polyadipic acid, polyterephtalic acid, poly(bis(p-carboxyphenoxy)alkane acid, or, more broadly, the polyanhydrides described, e.g., in Advanced Drug Delivery Reviews 54 (2002) 889-910, further including at least one reactive moiety selected from the group consisting of acrylate, methacrylate, vinyl ether, N-vinyl ether, vinyl ester, thiolene, maleate, epoxy, siloxane, amine, lactone, phosphate, and carboxylate moieties;
the family of saccharides and polysaccharides, comprising in particular carrageenans, dextrans, cyclodextrins, such as hyaluronic acid, agarose, chitosan, chitin, alginate, starch, cellulose and derivatives thereof such as methylcellulose, ethylcellulose, hydroxyethylcellulose, methylhydroxyethylcellulose, ethylhydroxyethylcellulose, carboxymethylcellulose, hydroxypropylcellulose, or methylhydroxypropylcellulose, further including at least one reactive moiety selected from the group consisting of acrylate, methacrylate, vinyl ether, N-vinyl ether, vinyl ester, thiolene, maleate, epoxy, siloxane, amine, lactone, phosphate, and carboxylate moieties;
the family of ethers and polyethers, in particular comprising polyethylene glycols, further including at least one reactive moiety selected from the group consisting of acrylate, methacrylate, vinyl ether, N-vinyl ether, vinyl ester, thiolene, maleate, epoxy, siloxane, amine, lactone, phosphate, and carboxylate moieties; and
the family of amides and polyamides, in particular comprising poly(ester amide) or polyphthalamide, further including at least one reactive moiety selected from the group consisting of acrylate, methacrylate, vinyl ether, N-vinyl ether, vinyl ester, thiolene, maleate, epoxy, siloxane, amine, lactone, phosphate, and carboxylate moieties;
the family of polyurethanes, in particular comprising the reaction products of polyols and polyisocyanates, the reaction products further including at least one reactive moiety selected from the group consisting of acrylate, methacrylate, vinyl ether, N-vinyl ether, vinyl ester, thiolene, maleate, epoxy, siloxane, amine, lactone, phosphate, and carboxylate moieties. Examples of the aforementioned polyols include 1,4-butanediol, 1,2-propanediol, hexanediol, neopentyl glycol, diethylene glycol, dipropylene glycol, methylpropanediol, bisphenol A, polyoxypropylene diol, polybutadiene diol, oxytetramethylene glycol, ethylene glycol adipate diol, polyethylene adipate glycol propylene glycol diol, polyadipate diethylene glycol diol, polyethylene adipate-diethylene glycol ester diol, pentaerythritol, glycerol, trimethylolpropane, trishydroxyethylpropane, or oxypropylene triol. Examples of the aforementioned polyisocyanates include hexamethylene diisocyanate derivatives, methylene dicyclohexyl diisocyanate derivatives, or isophorone diisocyanate derivatives.

In one preferred embodiment, the crosslinked polymer is selected from the group consisting of crosslinked polyesters, crosslinked polyepoxys, and crosslinked polyurethanes.

Preferably, the crosslinked polymer of the envelope of the solid microcapsules is obtained by polymerizing a composition C2 comprising at least one monomer or polymer having at least one reactive moiety as defined above, at least one crosslinking agent, and optionally at least one crosslinking photoinitiator or catalyst.

‘Crosslinking agent’ refers to a compound including at least two reactive moieties capable of crosslinking a monomer or polymer, or a mixture of monomers or polymers, during polymerization.

The crosslinking agent may be selected from molecules having at least two identical or different moieties selected from the group consisting of acrylate, methacrylate, vinyl ether, N-vinyl ether, vinyl ester, thiolene, maleate, epoxy, siloxane, amine, lactone, phosphate, carboxylate moieties.

Examples of crosslinking agents include, inter alia:
diacrylates, such as 1,6-hexanediol diacrylate, 1,6-hexanediol dimethacrylate, polyethylene glycol diacrylate, polyethylene glycol dimethacrylate, 1,9-nonanediol dimethacrylate, 1,4-butanediol dimethacrylate, 1,3-butanediol dimethacrylate, 1,10-decanediol dimethacrylate, bis(2-methacryloxyethyl) N,N′-1,9-nonylene biscarbamate, 1,4-butanediol diacrylate, 1,5-pentanediol dimethacrylate, allyl methacrylate, N,N′-methylenebisacrylamide, 2,2-bis[4-(2-hydroxy-3-methacryloxypropoxy)phenyl]propane, tetraethylene glycol diacrylate, diethylene glycol diacrylate, triethylene glycol diacrylate, triethylene glycol dimethacrylate, polyethylene glycol diglycidyl ether, N,N-diallylacrylamide, or glycidyl methacrylate;
multifunctional acrylates such as dipentaerythritol pentaacrylate, 1,1,1-trimethylolpropane triacrylate, 1,1,1-trimethylolpropane trimethacrylate, ethylenediamine tetramethacrylate, pentaerythritol triacrylate, or pentaerythritol tetraacrylate; and
acrylates that also include another reactive moiety, such as propargyl methacrylate, N-acryloxysuccinimide, N-(2-Hydroxypropyl)methacrylamide, N-(t-BOC-aminopropyl)methacrylamide, monoacryloxyethyl phosphate, acrylic anhydride, 2-(tert-butylamino)ethyl methacrylate, N,N-diallylacrylamide, or glycidyl methacrylate.

‘Photoinitiator’ refers to a compound capable of fragmenting under the effects of light radiation.

Photoinitiators that may be used according to this invention are known from the prior art, and are described, e.g., in “Les photoinitiateurs dans la réticulation des revêtements”, G. Li Bassi, Double Liaison—Chimie des Peintures, nº361, novembre 1985, p. 34-41; “Applications industrielles de la polymérisation photoinduite”, Henri Strub, L'Actualité Chimique, février 2000, p. 5-13; and “Photopolymères: considérations théoriques et réaction de prise”, Marc, J. M. Abadie, Double Liaison—Chimie des Peintures, nº435-436, 1992, p. 28-34.

These photoinitiators include:
α-hydroxyketones, such as 2-hydroxy-2-methyl-1-phenyl-1-propanone, e.g. those marketed under the names DAROCUR® 1173 and 4265, IRGACURE® 184, 2959, and 500 by BASF, and ADDITOL® CPK, by CYTEC;
α-aminoketones, in particular 2-benzyl-2-dimethylamino-1-(4-morpholinophenyl)-butanone-1, e.g. those marketed under the names IRGACURE® 907 and 369 by BASF;
aromatic ketones, e.g. those marketed under the name ESACURE® TZT by LAMBERTI; or thioxanthones, e.g. those marketed under the name ESACURE® ITX by LAMBERTI, and quinones. More often than not, these aromatic ketones require the presence of a hydrogen donor compound such as tertiary amines and, in particular, alkanolamines. Examples include the tertiary amine ESACURE® EDB marketed by LAMBERTI.
α-dicarbonyle derivatives, the most common example of which is benzyldimethylketal, marketed under the name IRGACURE® 651 by BASF. Other commercial products are marketed by LAMBERTI under the name ESACURE® KB1, and
acylphosphine oxides, e.g. the bis-acylphosphine oxides (BAPO), e.g. those marketed under the names IRGACURE® 819, 1700, and 1800, DAROCUR® 4265, LUCIRIN® TPO, and LUCIRIN® TPO-L by BASF.

Other examples of photoinitiators include aromatic ketones such as benzophenone, phenylglyoxylates, such as phenyl glyoxylic acid methyl ester, oxime esters such as [1-(4-phenylsulfanylbenzoyl)heptylideneamino]benzoate, sulphonium salts, iodonium salts, and oxime sulphonates.

In one embodiment, the solid microcapsules are obtained by a method comprising the following steps:
a) adding, whilst stirring, a composition C1 as defined above, to a polymer composition C2, wherein the compositions C1 and C2 are not miscible,
wherein the viscosity of the composition C2 is between 500 mPa·s and 100 000 mPa·s at 25° C., and is preferably greater than the viscosity of composition C1, wherein the composition C2 comprises:
at least one monomer or polymer having at least one reactive moiety as defined above,
at least one crosslinking agent, and
optionally at least one crosslinking photoinitiator or catalyst,
resulting in an emulsion (E1) comprising drops of composition C1 dispersed in the composition C2;
b) adding, whilst stirring, the emulsion (E1) to a composition C3, wherein the compositions C2 and C3 are not miscible,
wherein the viscosity of the composition C3 is between 500 mPa·s and 100 000 mPa·s at 25° C., and is preferably greater than the viscosity of the emulsion (E1),
resulting in a double emulsion (E2) comprising drops dispersed in the composition C3;
c) applying a shear stress to the emulsion (E2),
resulting in a double emulsion (E3) comprising drops of controlled size dispersed in the composition C3; and
d) polymerizing the composition C2,
resulting in solid microcapsules dispersed in the composition C3.

The aforementioned method consists of forming a double emulsion consisting of droplets containing at least one perfuming agent, surrounded by a crosslinkable liquid phase. These double drops are then made monodispersed in size before being transformed by crosslinking or polymerization into rigid capsules. Preparation involves 4 steps, which are described in detail below.

In one embodiment, the method according to the invention comprises a preliminary step prior to the aforementioned step a) of preparing a composition C1 in the form of an emulsion.

In this step, a composition c1 comprising a perfuming agent is added to a hydrophilic composition c2, wherein this step is carried out with stirring, which means that the composition C1 is stirred, typically mechanically, whilst the composition c1 comprising the perfuming agent is added, in order to emulsify the mixture of the composition C1.

During this step, the composition c1 comprising the perfuming agent is at a temperature between 0° C. and 100° C., preferably between 10° C. and 80° C., and more preferably between 15° C. and 60° C. During this step, the hydrophilic composition c2 is at a temperature between 0° C. and 100° C., preferably between 10° C. and 80° C., and more preferably between 15° C. and 60° C.

To carry out this step, any type of stirrer commonly used to form emulsions may be used, e.g. a mechanical blade stirrer, a static emulsifier, an ultrasound homogenizer, a membrane homogenizer, a high-pressure homogenizer, a colloid mill, a high-shear disperser, or a high-speed homogenizer.

In one embodiment, the hydrophilic composition hydrophile c2 contains a gellant.

In another embodiment, a gelling agent is added to the composition C1 once the composition c1 containing the perfuming agent has been emulsified in the hydrophilic composition c2. In this embodiment, to add the gellant to the composition C1, any type of stirrer used to homogenize a solution may be used, e.g. a mechanical blade stirrer at low rotation speed.

Step a) of the method according to the invention consists of preparing a first emulsion (E1).

The first emulsion consists of a dispersion of droplets of the composition C1 (comprising at least one perfuming agent) in a polymer composition C2 that is not miscible with C1, created by dropwise addition of C1 to C2 with stirring.

In step a), a composition C1 is added to a crosslinkable polymer composition C2, wherein this step is carried out with stirring, which means that the composition C2 is stirred, typically mechanically, whilst the composition C1 is added, in order to emulsify the mixture of the compositions C1 and C2.

The addition of the composition C1 to the composition C2 is typically dropwise.

During step a), the composition C1 is at a temperature between 0° C. and 100° C., preferably between 10° C. and 80° C., and more preferably between 15° C. and 60° C. During step a), the composition C2 is at a temperature between 0° C. and 100° C., preferably between 10° C. and 80° C., and more preferably between 15° C. and 60° C.

Under the addition conditions of step a), the compositions C1 are C2 not miscible, which means that the quantity (by weight) of the composition C1 that can be solubilized in the composition C2 is less than or equal to 5%, preferably less than 1%, and more preferably less than 0.5%, relative to the total weight of the composition C2, and that the quantity (by weight) of the composition C2 that can be solubilized in the composition C1 is less than or equal to 5%, preferably less than 1%, and more preferably less than 0.5%, relative to the total weight of the composition C1.

Thus, when the composition C1 comes into contact with the composition C2 under stirring, the latter is dispersed in the form of drops (‘single drops’).

The miscibility of the compositions C1 and C2 also makes it possible to avoid the migration of the active ingredient of the composition C1 to the composition C2.

The composition C2 is stirred so as to form an emulsion comprising drops of the composition C1 dispersed in the composition C2. This emulsion is also referred to as a ‘simple emulsion’, or C1-in-C2 emulsion.

To carry out step a), any type of stirrer commonly used to form emulsions may be used, e.g. a mechanical blade stirrer, a static emulsifier, an ultrasound homogenizer, a membrane homogenizer, a high-pressure homogenizer, a colloid mill, a high-shear disperser, or a high-speed homogenizer.

The composition C2 will eventually form the solid envelope of the microcapsules.

The volume fraction of C1 in C2 may vary from 0.1-0.6 in order to control the thickness of the envelope of the capsules resulting from the method.

In one embodiment, the ratio of the volume of the composition C1 to that of the composition C2 varies between 1:10 and 10:1. Preferably, the ratio is between 1:3 and 5:1, more preferably between 1:3 and 3:1.

Preferably, the viscosity of the composition C2 at 25° C. is between 1 000 mPa·s and 50 000 mPa·s, more preferably between 2 000 mPa·s and 25 000 mPa·s, e.g. between 3 000 mPa·s and 15 000 mPa·s.

Preferably, the viscosity of the composition C2 is greater than that of the composition C1.

Viscosity is measured using a Haake Rheostress™ 600 rheometer equipped with a cone 60 mm in diameter at an angle of 2°, and a temperature regulation cell set to 25° C. The viscosity reading is taken at a shear rate of 10 s⁻¹.

In this embodiment, the destabilization kinetics of the drops of the emulsion (E1) is quite slow, allowing the envelope of the microcapsules to be polymerized in step d) before the emulsion is destabilized. Upon completion, the polymerization thus provides thermodynamic stabilization. Thus, the relatively high viscosity of the composition C2 ensures the stability of the emulsion (E1) resulting from step a).

Preferably, the interfacial tension between the compositions C1 and C2 is low. Typically, these interfacial tensions vary between 0 mN/m and 50 mN/m, preferably between 0 mN/m and 20 mN/m.

The low interfacial tension between the compositions C1 and C2 also advantageously makes it possible to ensure the stability of the emulsion (E1) resulting from step a).

The composition C2 contains at least one monomer or polymer as defined above, at least one crosslinking agent as defined above, and optionally at least one crosslinking photoinitiator or catalyst as defined above, thus making it crosslinkable.

In one embodiment, the composition C2 comprises 50-99 wt % of the monomer or polymer as defined above, or a mixture of monomers or polymers as defined above, relative to the total weight of the composition C2.

In one embodiment, the composition C2 comprises de 1-20 wt % of the crosslinking agent or mixture of crosslinking agents as defined above, relative to the total weight of the composition C2.

In one embodiment, the composition C2 comprises de 0.1-5 wt % of the photoinitiator or mixture of photoinitiators as defined above, relative to the total weight of the composition C2.

In one embodiment, the composition C2 comprises 0.001-20 wt % of crosslinking agent(s) relative to the total weight of the composition.

In one embodiment, the composition C2 may further comprise an additional monomer or polymer capable of improving the property of the envelope of the microcapsules and/or conferring new properties on the envelope of the microcapsules.

Examples of these additional monomers or polymers include monomers or polymers having a pH-sensitive, temperature-sensitive, or UV- or IR-sensitive group.

These additional monomers or polymers may induce rupture in the solid microcapsules, and, thus, the release of their content, following stimulation, e.g. by pH, temperature, UV, or IR.

These additional monomers or polymers may be selected from monomers or polymers having at least one of the following groups:
a pH-sensitive group such as primary, secondary, or tertiary amines, carboxylic acids, phosphate, sulphate, nitrate, or carbonate groups;
a UV-sensitive or UV-cleavable group (or photochromic group) such as azobenzene, spiropyrane, 2-diazo-1,2-naphthoquinone, o-nitrobenzylated, thiol, or 6-nitro-veratroyloxycarbonyle groups, e.g. poly(ethylene oxide)-bloc-poly(2-nitrobenzylmethacrylate), and other block copolymers, as described, e.g., in Liu et al., Polymer Chemistry 2013, 4, 3431-3443;
an IR-sensitive or IR-cleavable group such as o-nitrobenzyle or 2-diazo-1,2-naphthoquinone, e.g. the polymers described in Liu et al., Polymer Chemistry 2013, 4, 3431-3443;
a hydrolysis-sensitive group, such as poly(lactic acid), poly(glycolic acid), poly(lactic-co-glycolic) acid, polycaprolactone, polyhydroxybutyrate, chitosan, dextran, agarose, cellulose, and derivatives thereof; and
a temperature-sensitive group such as poly(N-isopropylacrylamide).

Step b) of the method according to the invention consists of preparing a second emulsion (E2).

The second emulsion consists of a dispersion of droplets of the first emulsion in a composition C3 that is not miscible with C2, created by dropwise addition of the emulsion (E1) to C3 with stirring.

During step b), the emulsion (E1) is at a temperature between 15° C. and 60° C. During step b), the composition C3 is at a temperature between 15° C. and 60° C.

Under the addition conditions of step b), the compositions C2 are C3 not miscible, which means that the quantity (by weight) of the composition C2 that can be solubilized in the composition C3 is less than or equal to 5%, preferably less than 1%, and more preferably less than 0.5%, relative to the total weight of the composition C3, and that the quantity (by weight) of the composition C3 that can be solubilized in the composition C2 is less than or equal to 5%, preferably less than 1%, and more preferably less than 0.5%, relative to the total weight of the composition C2.

Thus, when the emulsion (E1) comes into contact with the composition C3 with stirring, the latter is dispersed in the form of drops ('double drops'); the dispersion of these drops of emulsion (E1) in the continuous phase C3 is referred to as emulsion (E2).

Typically, a double drop formed in step b) corresponds to a single drop of the composition C1 as described above, surrounded by an envelope of composition C2 that totally encapsulates the single drop.

The double drop formed in step b) may also comprise at least two single drops of composition C1, the single drops being surrounded by an envelope of composition C2 that totally encapsulates the single drops.

Thus, the double drops comprise a core consisting of one or more single drops of composition C1 and a layer of composition C2 surrounding the core.

The resultant emulsion (E2) is generally a double polydispersed emulsion (C1-in-C2-in-C3 or C1/C2/C3 emulsion), which means that the double drops do not have a clear size distribution in the emulsion (E2).

The fact that the compositions C2 and C3 are not miscible makes it possible to avoid mixing the layer of composition C2 and the composition C3, and also ensures the stability of the emulsion (E2).

The fact that the compositions C2 and C3 are not miscible also prevents the water-soluble substance of the composition C1 migrating from the core of the drops to the composition C3.

To carry out step b), any type of stirrer commonly used to form emulsions may be used, e.g. a mechanical blade stirrer, a static emulsifier, an ultrasound homogenizer, a membrane homogenizer, a high-pressure homogenizer, a colloid mill, a high-shear disperser, or a high-speed homogenizer.

In one embodiment, the viscosity of the composition C3 at 25° C. is greater than that of the emulsion (E1) at 25° C.

According to the invention, the viscosity of the composition C3 at 25° C. is between 500 mPa·s and 100 000 mPa·s.

Preferably, the viscosity of the composition C3 at 25° C. is between 3 000 mPa·s and 100,000 mPa·s, more preferably between 5 000 mPa·s and 80 000 mPa·s, e.g. between 7 000 mPa·s and 70 000 mPa·s.

In this embodiment, given the very high viscosity of the continuous phase formed by the composition C3, the destabilization rate of the double drops of the emulsion (E2) is quite slow relative to the duration of the method according to the invention, which thus allows for kinetic stabilization of the emulsions (E2) and (E3) until the envelope of the capsules has been fully polymerized. Once polymerized, the capsules are thermodynamically stable.

Thus, the very high viscosity of the composition C3 ensures the stability of the emulsion (E2) resulting from step b).

Low surface tension between C3 and the first emulsion, as well as the high viscosity of the system, advantageously ensure the kinetic stability of the double emulsion (E2), thus preventing it dephasing over the duration of the production method.

Preferably, the interfacial tension between the compositions C2 and C3 is low. The low interfacial tension between the compositions C2 and C3 also advantageously makes it possible to ensure the stability of the emulsion (E2) resulting from step b).

The volume fraction of the first emulsion in C3 may vary from 0.05-0.5 in order, on the one hand, to improve production performance, and, on the other, to vary the mean diameter of the capsules. At the end of this step, the size distribution of the second emulsion is relatively broad.

In one embodiment, the ratio of the volume of the emulsion (E1) to that of the composition C3 varies between 1:10 and 10:1. Preferably, the ratio is between 1:9 and 3:1, more preferably between 1:9 and 1:1.

In one embodiment, the composition C3 further comprises at least one branched polymer, preferably having a molecular weight greater than 5 000 g·mol-1, and/or at least one polymer having a molecular weight greater than 5 000 g·mol-1, and/or solid particles such as silicates.

In one embodiment, the composition C3 comprises at least one branched polymer, preferably having a molecular weight greater than 5 000 g·mol-1, preferably between 10 000 g·mol-1 and 500 000 g·mol-1, e.g. between 50 000 g·mol-1 and 300 000 g·mol-1.

‘Branched polymer’ refers to a polymer having at least one branching point between its two terminal groups; a ‘branching point’ is a point on a chain at which a side chain (also referred to as a ‘pendant chain’) is attached.

Examples of branched polymers include grafted polymers, comb polymers, star polymers, or dendrimers.

In one embodiment, the composition C3 comprises at least one branched polymer having a molecular weight greater than 5 000 g·mol-1, preferably between 10 000 g·mol-1 and 500 000 g·mol-1, e.g. between 50 000 g·mol-1 and 300 000 g·mol-1.

Examples of polymers that may be used in the composition C3 include the following compounds, used alone or mixed with one another:
cellulose derivatives, such as cellulose ethers: methylcellulose, ethylcellulose, hydroxyethylcellulose, methylhydroxyethylcellulose, ethylhydroxyethylcellulose, carboxymethylcellulose, hydroxypropylcellulose or methylhydroxypropylcellulose;
polyacrylates (also known as carbomers), such as polyacrylic acid (PAA), polymethacrylic acid (PMAA), poly(hydroxyethyl methacrylate) (pHEMA), poly(N-2-hydroxypropyl methacrylate) (pHPMA);
polyacrylamides such as poly(N-isopropylacrylamide) (PNIPAM);
polyvinylpyrrolidone (PVP) and derivatives thereof;
polyvinyl alcohol (PVA) and derivatives thereof;
poly(ethylene glycol), poly(propylene glycol), and derivatives thereof, such sa poly(ethylene glycol) acrylate/methacrylate, poly(ethylene glycol) diacrylate/dimethacrylate, polypropylene carbonate;
polysaccharides such as carrageenans, carob or tara goms, dextran, xanthan gums, chitosan, agarose, hyaluronic acids, gellan gum, guar gum, gum arabic, tragacanth gum, diutan gum, oat gum, karaya gum, ghatti gum, curdlan gum, pectin, konjac gum, starch;
protein derivatives such as gelatin, collagen, fibrin, polylysine, albumin, casein;
silicone derivatives such as polydimethylsiloxane (also known as dimethicone), alkyl silicones, aryl silicones, alkylaryl silicones, polyethylene glycol dimethicones, polypropylene glycol dimethicones;
waxes, such as diester waxes (alkanediol diesters, hydroxyl acid diesters), trimester waxes (triacylglycerols, alkane-1,2-diol triesters, ω-hydroxy acid and fatty acid triesters, hydroxymalonic acid, fatty acid, and alcohol esters, hydroxyl acid, fatty acid, and fatty alcohol triesters, fatty acid, hydroxyl acid, and diol triesters), and polyester waxes (fatty acid polyesters). Examples of fatty acid esters that can be used as waxes in the invention include palmitate de cetyl, cetyl octanoate, cetyl laurate, cetyl lactate, cetyl isononanoate, cetyl stearate, stearyl stearate, myristyl stearate, cetyl myristate, isocetyl stearate isocetyl, glyceryl trimyristate, glyceryl tripalmitate, glyceryl monostearate, or glyceryl and cetyl palmitate;
fatty acids that can be used as waxes such as cerotic acid, palmitic acid, stearic acid, dihydroxystearic acid, behenic acid, lignoceric acid, arachidic acid, myristic acid, lauric acid, tridecyclic acid, pentadecyclic acid, margaric acid, nonadecyclic acid, heneicosylic acid, tricosylic acid, pentacosylic acid, heptacosylic acid, montanic acid, or nonacosylic acid;
fatty acid salts, in particular fatty acid aluminium salts such as aluminium stearate, hydroxyl aluminium bis(2-ethylhexanoate);
isomerised jojoba oil;
hydrogenated sunflower oil;
hydrogenated coconut oil;
hydrogenated lanolin oil;
castor oil and derivatives thereof, in particular modified hydrogenated castor oil, or compounds obtained by esterification of castor oil with fatty alcohols;
polyurethanes and derivatives thereof;
styrene polymers such as styrene butadiene; and
polyolefins such as polyisobutene.

In one embodiment, the composition C3 comprises solid particles such as clays, silicas, and silicates.

Examples of solid particles that can be used in the composition C3 include clays and silicates, in particularly in the category of phyllosilicates (also known as ‘flaky silica’). Examples of silicates that can be used in the invention include bentonite, hectorite, attapulgite, sepiolite, montmorillonite, saponite, sauconite, nontronite, kaolinite, talc, sepiolite, and chalk. Fumed synthetic silicates may also be used. The aforementioned clays, silicates, and silicas may advantageously be modified by organic molecules such as polyethers, ethoxylated amides, quarternary ammonium salts, long-chain diamines, long-chain esters, polyethylene glycols, and polypropylene glycols.

These particles may be used alone or mixed with one another.

In one embodiment, the composition C3 comprises at least one polymer having a molecular weight greater than 5 000 g·mol⁻¹ and solid particles. Any mixture of the aforementioned compounds may be used.

Step c) of the method according to the invention consists of adjusting the size of the drops of the second emulsion (E2).

This step may consist of applying a controlled homogeneous shearing stress to the emulsion (E2), with the shear rate applied being between 10 s-1 and 100 000 s-1.

In one embodiment, the polydisperse double drops obtained from step b) are subjected to size adjustment, consisting of subjecting them to shearing stresses capable of fragmenting them into new double drops having homogeneous, controlled diameters. Preferably, this shearing step is carried out using a Couette high-shear cell according to a method described in patent application EP 15 306 428.2.

In one embodiment, in step c), the second emulsion (E2), resulting from step b), which consists of polydispersed double drops dispersed in a continuous phase, is subjected to shearing in a mixer that applies a controlled homogeneous shearing stress.

Thus, in this embodiment, step c) consists of applying a controlled homogeneous shearing stress to the emulsion (E2), with the shear rate applied being between 1,000 s⁻¹ and 100 000 s-1.

In this embodiment, in a mixer, the shear rate is considered controlled and homogeneous, independently of duration, if it occurs at an identical maximum value for all parts of the emulsion at a given time that may vary from one point in the emulsion to another. The exact configuration of the mixer is not essential to the invention, given that the entire emulsion has been subjected to the same maximum shear upon exiting the device. Mixers suited to carry out step c) are described, inter alia, in document U.S. Pat. No. 5,938,581.

The second emulsion may be subjected to homogeneous controlled shearing whilst it circulates through a cell consisting of:
two concentric rotary cylinders (also known as a ‘Couette mixer’);
two parallel rotary disks; or
two parallel oscillating plates.

In this embodiment, the shear rate applied to the second emulsion is between 1 000 s⁻¹ and 100 000 s⁻¹, preferably between 1 000 s⁻¹ and 50 000 s⁻¹, and more preferably between 2 000 s⁻¹ and 20 000 s⁻¹.

In this embodiment, in step c), the second emulsion is inserted into the mixer and then subjected to a shearing stress resulting in the formation of the third emulsion. The third emulsion (E3) is chemically identical to the second emulsion (E2), but consists of monodispersed double drops, whilst the emulsion (E2) consists of polydispersed double drops. Typically, the third emulsion (E3) consists of a dispersion of double drops comprising a core consisting of one or more drops of the composition C1 and a layer of the composition C2 encapsulating the core, the double drops being dispersed in the composition C3.

The difference between the second emulsion and the third emulsion is the variance in the size of the double drops: The drops of the second emulsion are polydispersed in size, whilst the drops of the third emulsion are monodispersed, due to the fragmentation mechanism described above.

Preferably, in this embodiment, the second emulsion is inserted continuously into the mixer, meaning that the quantity of the double emulsion (E2) inserted at the inlet of the mixer is the same as the quantity of third emulsion (E3) at the outlet of the mixer.

Given that the size of the drops of the emulsion (E3) essentially corresponds to that of the drops of the solid microcapsules following polymerization, it is possible to adjust the size of the microcapsules and the thickness of the envelope by adjusting the shear rate in step c), with a high correlation between reduction in drop size and increase in shear rate. This allows for adjustments to the resultant dimensions of the microcapsules by varying the shear rate applied in step c).

In one preferred embodiment, the mixer used in step c) is a Couette mixer comprising two concentric cylinders, an external cylinder having an internal radius Ro and an internal cylinder having an external radius Ri, the external cylinder being fixed and the internal cylinder rotating at an angular velocity ω.

A Couette mixer suitable for the method according to the invention may be obtained from T.S.R. France.

In one embodiment, the angular velocity ω of the rotary internal cylinder of the Couette mixer is greater than or equal to 30 rad·s-1.

For example, the angular velocity w of the rotary internal cylinder of the Couette mixer is app. 70 rad·s-1.

The dimensions of the fixed external cylinder of the Couette mixer may be selected so as to modulate the space (d=Rₒ−Rᵢ) between the rotary internal cylinder and the fixed external cylinder.

In one embodiment, the space (d=Rₒ−Rᵢ) between the two concentric cylinders of the Couette mixer is between 50 μm and 1 000 μm, preferably between 100 μm and 500 μm, e.g. between 200 μm and 400 μm.

For example, the distance d between the two concentric cylinders is equal to 100 μm.

In this embodiment, during step c), the second emulsion is inserted at the inlet of the mixer, typically by means of a pump, and directed to the space between the two concentric cylinders, the external cylinder being fixed and the internal cylinder being rotary at an angular velocity ω.

Whilst the double emulsion is in the space between the two cylinders, the shear rate applied to the emulsion is given by the following equation:

$$γ = \frac{{R}_{t} ω}{( {R}_{o} - {R}_{i} )}$$

wherein
ω is the angular velocity of the internal rotary cylinder,
Rₒ is the internal radius of the fixed external cylinder, and
Rᵢ is the external radius of the rotary internal cylinder.

In another embodiment, when the viscosity of the composition C3 is greater than 2 000 mPa·s at 25° C., step c) consists of applying a shear rate less than 1 000 s⁻¹ to the emulsion (E2).

In this embodiment, the fragmentation step c) may be carried out using any type of mixer commonly used to form emulsions at a shear rate less than 1 000 s⁻¹, in which case the viscosity of the composition C3 is greater than 2 000 mPa·s, i.e., in conditions as described in patent application FR 16 61787.

The geometric characteristics of the double drops formed at the end of this step will determine those of the future capsules.

In this embodiment, in step c), the emulsion (E2), which consists of polydispersed drops dispersed in a continuous phase, is subjected to a shearing stress, e.g. in a mixer, at a low shear rate, i.e. less than 1 000 s⁻¹.

In this embodiment, for example, the shear rate applied in step c) is between 10 s⁻¹ and 1 000 s⁻¹.

Preferably, the shear rate applied in step c) is strictly less than 1 000 s⁻¹.

In this embodiment, the drops of the emulsion (E2) cannot be effectively fragmented into fine, monodispersed drops of the emulsion (E3) unless a high shear stress is applied to them.

The shear stress σ applied to a drop of the emulsion (E2) is defined as the tangential force per unite of surface area of the drop resulting from the macroscopic shear applied to the emulsion during stirring in step d).

The shear stress σ (expressed in Pa), the viscosity of the composition C3 η (expressed in Pa s), and the shear rate γ (expressed in s-1) applied to the emulsion (E2) during stirring in step d) are linked by the following equation:

$$σ = ηγ$$

Thus, in this embodiment, the elevated viscosity of the composition C3 allows for the application of a very high shear stress to the drops of emulsion (E2) in the mixer, even if the shear rate is low and the shear is inhomogeneous.

To carry out step c), in this embodiment, any type of stirrer commonly used to form emulsions may be used, e.g. a mechanical blade stirrer, a static emulsifier, an ultrasound homogenizer, a membrane homogenizer, a high-pressure homogenizer, a colloid mill, a high-shear disperser, or a high-speed homogenizer.

In one preferred embodiment, a simple emulsifier such as a mechanical blade stirrer or a static stirrer is used to carry out step c). Indeed, this is possible because this embodiment requires neither controlled shearing or a greater shear than 1 000 s⁻¹.

Step d) of the method according to the invention consists of crosslinking, and thus of forming the envelope of the solid microcapsules according to the invention.

This step both allows the expected capsule retention performance to be attained and to ensure their thermodynamic stability whilst definitively preventing any destabilization mechanisms such as coalescence or curing.

In one embodiment, when the composition C2 comprises a photoinitiator, step d) is a photopolymerization step consisting of exposing the emulsion (E3) to a light source suited to initiate the photopolymerization of the composition C2, in particular a UV light source, preferably emitting in the wavelength range between 100 nm and 400 nm, in particular for a duration shorter than 15 min.

In this embodiment, step d) consists of subjecting the emulsion (E3) to photopolymerization, which will allow for the photopolymerization of the composition C2. This step will make it possible to obtain microcapsules that encapsulate the water-soluble substance as defined above.

In one embodiment, step d) consists of exposing the emulsion (E3) to a light source suitable to initiate the photopolymerization of the composition C2.

Preferably, the light source is a UV light source.

In one embodiment, the UV light source emits in the wavelength range between 100 nm and 400 nm.

In one embodiment, the emulsion (E3) is exposed to a light source for a duration shorter than 15 min, and preferably for 5-10 min.

In step d), the envelope of the aforementioned double drops, consisting of photocrosslinkable composition C2, is crosslinked, and thus transformed into a viscoelastic polymer envelope encapsulating and protecting the water-soluble substance from release in the absence of a mechanical trigger.

In another embodiment, if the composition C2 does not comprise a photoinitiator, step d) is a polymerization step without exposure to a light source, wherein the duration of this polymerization step d) is preferably between8 and 100 h and/or this step d) is carried out at a temperature between 20° C. and 80° C.

In this embodiment, polymerization is initiated, e.g., by exposure to heat (thermal initiation), or by simply putting the monomers, polymers, and crosslinking agents into contact with one another, or with a catalyst. The polymerization time in this case is generally greater than several hours.

Preferably, step d) of polymerizing the composition C2 is carried out for a duration between 8 and 100 h, at a temperature between 20° C. and 80° C.

The composition resulting from step d), comprising solid microcapsules dispersed in the composition C3, is ready for use, and may be used without the need for any additional post-treatment step for the capsules.

The thickness of the envelope of the microcapsules thus obtained is between 0.1 μm and 20 μm, preferably between 0.2 μm and 8 μm, and more preferably between 0.2 μm and 5 μm.

In one embodiment, the solid microcapsules resulting from step d) are free of surfactant.

The method according to the invention has the advantage of not requiring any surfactants in any of the steps described. Thus, the method according to the invention allows for reduction in the amount of additives that might modify the properties of the final product obtained following the release of the perfuming agent.

This invention also concerns the use of a composition as defined above for washing and/or caring for fabrics.

This invention also concerns the use of the microcapsules as defined above to improve the olfactory and/or sensory properties of a fabric washing and/or care composition.

This invention also concerns the use of the microcapsules as defined above to reduce, or prevent, the evaporation of the perfuming agent provided by the microcapsules.

The expressions ‘between . . . and . . . ’ and ‘from . . . - . . . ’ are to be construed as inclusive, unless otherwise specified.

The following examples illustrate this invention without limiting its scope.

### EXAMPLES

### Example 1

### Preparation of the Microcapsules

A mechanical stirrer (Ika Eurostar 20) equipped with a saw tooth propeller is used to carry out all stirring steps.

### Preparation of Composition C1

TABLE 1

| | | Mass | Proportion |
|---|---|---|---|
| | Raw materials | (g) | (%) |
| Phase A | Romance 0330 (IFF) | 7.84 | 40 |
| | Neobee M5 (Stepan) | 1.96 | 10 |
| | Pluronic L81 (Sigma Aldrich) | 0.2 | 1 |
| Phase B | Tween 80 (Sigma Aldrich) | 0.4 | 2 |
| | Deionized water | 9.2 | 47 |

| | | |
|---|---|---|
| Total | 19.6 | 100 |

The ingredients of phase A are stirred together at 300 rpm until homogenization. To prepare phase B, Tween 80 is gradually added to distilled water with stirring at 2000 rpm until homogenization. Phase A is then gradually added to phase B with stirring at 2000 rpm. The components are stirred for a 2 min, then sonicated (SFX 550, Branson) in an ice bath for 1.5 min (pulse 10 s/5 s) at 40% amplitude.

Following coiling, 1.4 g of Aculyn 44N gellant (Dow) is added to the mixture with stirring at 200 rpm until gelation in order to obtain composition C1.

### Preparation of the First Emulsion (E1)

TABLE 2

| | | % in | % in |
|---|---|---|---|
| | Raw materials | composition | E1 |
| Composition C1 | — | | 50 |
| Composition C2 | Aliphatic epoxy acrylate | 78.6 | 50 |
| | oligomer (Genomer 2312, | | |
| | Rahn) | | |
| | Propoxylated glyceryl | 20.4 | |
| | triacrylate oligomer | | |
| | (SR9020, Sartomer) | | |
| | Photoinitiator (Darocure | 1 | |
| | 1173, Sigma Aldrich) | | |

| | | |
|---|---|---|
| Total | 100 | 100 |

The composition C1 is gradually added to the composition C2 with stirring at 300 rpm.

### Preparation of the Second Emulsion (E2)

TABLE 3

| | | % in | % in |
|---|---|---|---|
| | Raw materials | composition | E2 |
| Emulsion E1 | — | | 5 |
| Composition C3 | Sodium alginate (Sigma | 11 | 95 |
| | Aldrich) | | |
| | Deionized water | 89 | |

| | | |
|---|---|---|
| Total | 100 | 100 |

The composition C3 is stirred at 1 000 rpm until complete homogenization, then allowed to rest for 1 h at room temperature (RT).

The first emulsion (E1) is then gradually added to the composition C3 with stirring at 2000 rpm. Thus, the second emulsion (E2) is obtained.

### Adjustment of the Size of the Second Emulsion

The second polydispersed emulsion (E2) resulting from the foregoing step is stirred at 2000 rpm for 3 min. This results in a monodispersed emulsion (E2).

### Crosslinking of the Envelope of the Capsules

The second monodispersed emulsion (E3), obtained in the previous step, is irradiated for 10 min using a UV light source (Dymax LightBox ECE 2000) with a maximum light intensity of 0.1 W/cm² at a wavelength of 365 nm.

The resultant microcapsules have an average size of 9.5 μm, and their size distribution has a standard deviation of 3.1 μm, i.e. 33%.

The resultant microcapsules are subjected to 3 successive dilution cycles with distilled water and centrifuged in order to produce a suspension of microcapsules in distilled water containing 50 mass % microcapsules.

### Example 2

### Biodegradability Test

The biodegradability of the microcapsules prepared according to Example 1 is measured according to OECD guideline 301 A, available at the OECD website at the following URL: https://www.oecd-ilibrary.org/fr/environment/essai-n-301-biodegradabilite-facile_9789264070356-fr.

In brief, the microcapsule suspensions are diluted with distilled water at a concentration such that their concentration in dissolved organic carbon (DOC) is between 10 and 40 mg DOC/L, and incubated with a seeding from an urban organic water treatment plant in a lightproof chamber with stirring at 22° C. The DOC analysis is carried out regularly, and a biodegradation rate of 70% in 28 days is found.

The microcapsules prepared according to Example 1 are thus biodegradable.

### Example 3

### Preparation of a Formula for a Main Wash Product

The following formula for a main wash product is provided:

TABLE 4

| | | % in |
|---|---|---|
| | Raw materials | composition |
| Biodegradable anionic | Sodium dodecylbenzene | 9.6 |
| surfactant | sulphonate (Sigma Aldrich) | |
| Biodegradable anionic | Sodium dodecyl sulphate | 5 |
| surfactant | (Sigma Aldrich) | |
| Biodegradable nonionic | C12-C15 ethoxylated | 5 |
| surfactant | alcohols (Tomadol 25-7, | |
| | Evonik) | |
| pH adjuster | Sodium hydroxide | 2.5 |
| Detergent additive | Sodium citrate (Sigma | 2 |
| | Aldrich) | |
| Antiredeposition agent | Polyacrylate (Acusol 445N, | 1 |
| | Dow) | |
| Biodegradable optical | 4,4′-distyryl biphenyl | 0.05 |
| brightener | derivative (Tinopal CBS-X, | |
| | BASF) | |
| Solvent | Deionized water | 72.35 |

| | |
|---|---|
| Total | 100 |

Two samples are prepared from this formula containing the same concentration of Romance 0330 perfume: Sample LP1 containing 5 mass % of microcapsules prepared according to Example 1 and sample LP2 containing 0.97 mass % Romance 0330 perfume.

### Example 4

### Formula for Fabric Softening Rinse

The following formula for a fabric softener is provided:

TABLE 5

| | | % in |
|---|---|---|
| | Raw materials | composition |
| Biodegradable cationic | TEA quat diester | 16.67 |
| softener compound | (Stepantex VT-90, | |
| | Stepan) | |
| Detergent additive | Sodium chloride | 0.15 |
| | (Sigma Aldrich) | |
| Solvent | Deionized water | 73.18 |

| | |
|---|---|
| Total | 100 |

Two samples are prepared from this formula containing the same concentration of Romance 0330 perfume: Sample AD1 containing 5 mass % of microcapsules prepared according to Example 1 and sample AD2 containing 0.97 mass % Romance 0330 perfume.

### Example 5

### Preparation of Washed Cotton Fabric Sample

10 g of one of the products produced according to Example 3 or 4 is mixed with 1 L deionized water. 5 6×10 cm cotton fabric samples are stirred for 5 min in the resultant solution, drained, then stirred for 2 min in 1 L deionized water, drained, and then dried in open air for 12 h.

### Example 6

### Sensory Test After 12 Hours

Cotton fabric samples prepared according to Example 5 are evaluated by a panel of 5 persons according to a scent intensity scale from 0-5, where 0 represents no scent and 5 an extremely strong scent. Each person has two fabric samples per fabric care product sample: One is evaluated intact, the other is evaluated after rubbing the fabric against itself. The intensities perceived for each sample (mean±SD) are shown in the table below:

TABLE 6

| | No rubbing | After rubbing |
|---|---|---|
| LP1 | 1.7 ± 0.6 | 3.9 ± 0.2 |
| LP2 | 2.5 ± 0.3 | 2.6 ± 0.4 |
| AD1 | 1.9 ± 0.5 | 4.0 ± 0.3 |
| AD2 | 2.7 ± 0.3 | 2.5 ± 0.5 |

These results show the targeting qualities of the microcapsules on fabric fibers with the two types of fabric care product tested. The intensity perceived before rubbing is lower in the samples containing microcapsules because the perfume is confined inside the microcapsules. Under the effect of rubbing, the microcapsules break to release the perfume inside. The intensity perceived following rubbing is thus greater in the samples containing the microcapsules, showing that the quantity of perfume deposited on the fibers of the fabric is greater than that deposited when the perfume is free.

### Example 7

### Sensory Test After 7 Days

Samples of cotton fabric prepared according to Example 5 are stored in a non-airtight box for 7 days, then evaluated by a panel of 5 persons according to the protocol described in Example 6. The intensities perceived for each sample (mean±SD) are shown in the table below:

TABLE 7

| | No rubbing | After rubbing |
|---|---|---|
| LP1 - 7j | 0.6 ± 0.3 | 2.5 ± 0.6 |
| LP2 - 7j | 0.3 ± 0.4 | 0.6 ± 04 |
| AD1 - 7j | 0.5 ± 0.5 | 1.8 ± 0.6 |
| AD2 - 7j | 0.5 ± 0.3 | 0.4 ± 0.5 |

These results show the protection against evaporation provided to the perfume by the microcapsules. Indeed, after rubbing, the intensity perceived is considerably greater when the perfume is encapsulated than when it is free, thus showing that the quantity of perfume remaining on the fabric after 7 days is greater.

1. A composition comprising:
at least one composition for washing and/or care of fabrics, and
at least one solid microcapsule having a mean diameter between 1 μm and 30 μm, comprising:
a core consisting of a composition C1 comprising at least one perfuming agent, wherein the composition C1 is in the form of an emulsion, and
a solid crosslinked-polymer envelope totally encapsulating the core at its circumference, wherein the solid envelope comprises a crosslinked polymer obtained by polymerizing at least one monomer or polymer having at least one reactive moiety selected from the group consisting of acrylate, methacrylate, vinyl ether, N-vinyl ether, vinyl ester, thiolene, maleate, epoxy, siloxane, amine, lactone, phosphate, and carboxylate moieties,
and wherein the thickness of the solid envelope is between 0.1 μm and 20 μm.

2. The composition according to claim 1, comprising solid microcapsules, wherein each of the solid microcapsules is as defined in claim 1, and wherein the standard deviation of the microcapsule diameter distribution is less than 50%, or less than 1 μm.

3. The composition according to claim 1, wherein the composition C1 of the core of the solid microcapsules comprises at least 20 wt % perfuming agent relative to the total weight of the composition C1.

4. The composition according to claim 1, wherein the composition C1 further comprises at least one aqueous gellant, preferably selected from the group consisting of cellulose derivatives, polyacrylates, polyvinylpyrrolidone polyacrylamide and derivatives thereof, polyvinyl alcohol and derivatives thereof, poly(ethylene glycol), poly(propylene glycol) and derivatives thereof, polysaccharides, protein-derivatives, polyurethanes and derivatives thereof, and clays and silicates.

5. The composition according to claim 4, wherein the composition C1 is in the form of an emulsion comprising a continuous phase in the form of an aqueous gel.

6. The composition according to claim 1, wherein the crosslinked polymer is obtained by polymerization from a monomer or polymer selected from aliphatic or aromatic esters or polyesters, urethanes or polyurethanes, anhydrides or polyanhydrides, saccharides or polysaccharides, ethers or polyethers, amides or polyamides, and carbonates or polycarbonates, wherein the monomers or polymers further include at least one reactive moiety selected from the group consisting of acrylate, methacrylate, vinyl ether, N-vinyl ether, vinyl ester, thiolene, maleate, epoxy, siloxane, amine, lactone, phosphate, and carboxylate moieties.

7. The composition according to claim 1, wherein the crosslinked polymer is selected from the group consisting of crosslinked polymers, crosslinked polyepoxys, and crosslinked polyurethanes.

8. The composition according to claim 1, wherein the crosslinked polymer of the envelope of the solid microcapsules is obtained by polymerizing a composition C2 comprising at least one monomer or polymer having at least one reactive moiety as defined in claim 1, at least one crosslinking agent, and optionally at least one crosslinking photoinitiator or catalyst.

9. The composition according to claim 1, wherein the solid microcapsules are obtained by a method comprising the following steps:
a) adding, whilst stirring, a composition C1 as defined in claim 1, to a polymer composition C2, wherein the compositions C1 and C2 are not miscible,
wherein the viscosity of the composition C2 is between 500 mPa·s and 100 000 mPa·s at 25° C., and is preferably greater than the viscosity of composition C1,
wherein the composition C2 comprises:
at least one monomer or polymer having at least one reactive moiety as defined in claim 1,
at least one crosslinking agent, and
optionally at least one crosslinking photoinitiator or catalyst,
resulting in an emulsion (E1) comprising drops of composition C1 dispersed in the composition C2;
b) adding, whilst stirring, the emulsion (E1) to a composition C3, wherein the compositions C2 and C3 are not miscible,
wherein the viscosity of the composition C3 is between 500 mPa·s and 100 000 mPa·s at 25° C., and is preferably greater than the viscosity of the emulsion (E1),
resulting in a double emulsion (E2) comprising drops dispersed in the composition C3;
c) applying a shear stress to the emulsion (E2),
resulting in a double emulsion (E3) comprising drops of controlled size dispersed in the composition C3; and
d) polymerizing the composition C2,
resulting in solid microcapsules dispersed in the composition C3.

10. The use of a composition according to claim 1 for washing and/or care of fabrics.
